(19) United States
(12) Patent Application Publication
(10) Pub. No.: US 2025/0157771 A1
(43) Pub. Date: May 15, 2025

(54) CIRCUIT BREAKER INTERLOCK MECHANISM

(71) Applicant: Rockwell Automation Switzerland GmbH, Aarau (CH)

(72) Inventors: Markus Gloor, Aarau (CH); Sadashiv Pimple, Zuchwil (CH); Rahel J. von Arx, Schinznach-Dorf (CH)

(21) Appl. No.: 18/505,948

(22) Filed: Nov. 9, 2023

(51) Int. Cl. H01H 71/50

(52) U.S. Cl. CPC H01H 71/501

(57) ABSTRACT

The present technology relates to a safety feature of industrial circuit breakers. More specifically, a mechanism is disclosed that prevents a circuit breaker switch from being turned to the off position when contact welds are present. In an embodiment, a circuit breaker includes an interlock component that interfaces with a rotary disk used for switching the device on and off. When no contact welds are present, the circuit breaker may be turned off and the interlock component rotates out of the way of the rotary disk due to linear motion resulting from separation of the contacts. However, when a contact weld exists, the interlock component does not move out of the way because no linear motion occurs due to failure to separate the welded contacts. In such a scenario, the interlock component catches an opposing undercut on the rotary disk preventing it from rotating past the point of interlock.

### INCORPORATIONS

The following U.S. Patent Applications, each of which are filed concurrently with the present application, are incorporated by reference herein in their entireties for all purposes: Attorney Docket No. 2023P-167-US, titled “CIRCUIT BREAKER LINEAR LEVER AND TRIPPING FORK MECHANISM,” Attorney Docket No. 2023P-168-US, titled “CIRCUIT BREAKER TRIPPING MECHANISM,” and Attorney Docket No. 2023P-175-US, titled “CIRCUIT BREAKER COMPENSATION BIMETAL OF A THERMAL TRIPPING MECHANISM.” Each of the applications describe features of a circuit breaker, all of which can be incorporated into a single circuit breaker to obtain the benefit of each of the described features.

### TECHNICAL FIELD

Various embodiments of the present technology generally relate to a safety feature of industrial circuit breakers. More specifically, an interlock mechanism is disclosed that prevents a circuit breaker switch from turning to the off position when contact welding is present in the device.

### BACKGROUND

Circuit breakers are electrical switching devices designed to protect electrical circuits from potential damage that can be caused by short circuits or overloads. Circuit breakers may be implemented in industrial environments as components of electrical circuits. When a circuit breaker is turned on, an electrical connection is created by bringing sets of metal contacts into physical contact with one another to allow current flow through the circuit. When the circuit breaker is turned off, the metal contacts are separated to interrupt the current flow in the circuit. Circuit breakers may be manually or automatically operated to switch the circuit breaker on and off.

In operation, contact welding may render a circuit breaker non-operational. Contact welding is a circuit breaker failure mode in which the metal contacts that open or close the electrical connection become welded together such that they can no longer be separated to stop current flow. Contact welding is caused by increases in thermal energy that melt the metal contacts sufficiently such that when they cool, they are fused together. Contact welding may occur from large spikes in overcurrent, repeated overcurrent over long periods, arcing, and the like. Once contacts are welded, the circuit breaker cannot turn off because the contacts cannot separate to interrupt current flow. This can affect the safety of nearby operators and technicians. For example, if the circuit breaker switch can be turned to the off position while the contacts are welded, the operator may incorrectly believe current is not flowing to the load devices connected to the circuit breaker. This exposes the operator to dangers such as electrocution, in addition to the danger of damaging connected load devices or the facility at large.

It is with respect to this general technical environment that aspects of the present disclosure have been contemplated. Furthermore, although a general environment is discussed, it should be understood that the described examples should not be limited to the general environment identified in the background.

### SUMMARY

This Overview is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Various embodiments of the present technology generally relate to a safety feature of industrial circuit breakers. More specifically, a mechanism is disclosed that prevents a circuit breaker switch from being turned to the off position when a contact weld is present in the circuit breaker. In an embodiment of the present technology, a circuit breaker includes a rotating power switch coupled to a rotary disk. The switch includes an on position corresponding to an on mode of the circuit breaker, an off position corresponding to an off mode of the circuit breaker, and a trip position corresponding to a trip mode of the circuit breaker. The circuit breaker further includes the rotary disk having a receptacle disposed on a circumferential edge of the rotary disk. The rotary disk rotates in a first plane about the first axis as the switch rotates. A linkage assembly moves axially in response to rotation of the rotary disk. The circuit breaker further includes an interlock component with a hook extending from a circumferential edge of a circular body of the interlock component. The interlock component and hook pivot in the first plane about a second axis parallel to the first axis in response to the movement of the linkage assembly. The hook of the interlock component is aligned to interface with the receptacle of the rotary disk in an aligned position. The hook of the interlock component is not aligned to interface with the receptacle of the rotary disk in an unaligned position.

In a normal operation of the circuit breaker, the interlock component pivots in response to movement of the linkage assembly from the aligned position corresponding to the switch in the on position to the unaligned position corresponding to the switch in the off position. In a tripping operation of the circuit breaker, the hook of the interlock component remains in the aligned position and interfaces with the receptacle of the rotary disk in response to rotation of the switch from the on position toward the off position. The switch stops in the trip position in response to the hook interfacing with the receptacle of the rotary disk. The tripping operation includes at least one of a set of moving contacts being welded to one of a set of stationary contacts.

In some embodiments, the circuit breaker further includes the set of moving contacts coupled to the rotary disk via the linkage assembly. The set of moving contacts change position between a first position corresponding to the on position of the switch and a second position corresponding to the off position of the switch in response to movement of the linkage assembly caused by rotation of the switch between the on position and the off position. The set of moving contacts physically contacts the set of stationary contacts in the first position corresponding to the on position of the switch allowing current to flow through the circuit breaker in the on mode. The set of moving contacts does not contact the set of stationary contacts in the second position corresponding to the off position of the switch stopping current flow through the circuit breaker in the off mode.

In some embodiments, the receptacle is at a first location on the circumferential edge of the rotary disk. In such embodiments, the rotary disk has a gear interface disposed at a second location on the circumferential edge. The circuit breaker may further include a gearing component coupled to the gear interface of the rotary disk and the linkage assembly. The gearing component translates rotation of the rotary disk to the movement of the linkage assembly axially along a third axis parallel to the first axis. The circuit breaker of claim 1 may further include the linkage assembly. The linkage assembly includes a rocker arm coupled to the set of moving contacts. In such an embodiment, movement of the linkage assembly moves the rocker arm, and, in response, the set of moving contacts change position between a first position corresponding to the on position of the switch and a second position corresponding to the off position of the switch.

In some embodiments, the circuit breaker includes the linkage assembly. The linkage assembly may be in a first position corresponding to the on position of the switch or in a second position corresponding to the off position of the switch. The linkage assembly may further include an extension component that pushes the interlock component into the aligned position in response to movement of the linkage assembly into the first position.

In some embodiments, the switch includes a rotating knob, the switch rotates ninety degrees between the on position and the off position, and the trip position is within the ninety degrees between the on position and the off position.

In some embodiments, the circuit breaker includes an interlock component housing surrounding at least a portion of the interlock component. The interlock component housing controls movement in at least one direction of the interlock component. In additional embodiments, the interlock component is comprised of plastic and the hook of the interlock component can withstand a force of up to three and one-half Newton-meters (3.5 Nm) before failing.

In another embodiment, a circuit breaker includes a switch, a rotary disk coupled to the switch, the rotary disk including a receptacle, a linkage assembly coupled to the rotary disk, a set of moving contacts coupled to the linkage assembly, and an interlock component coupled to the linkage assembly. The interlock component includes an interlocking hook. In a healthy state of the circuit breaker, the switch rotates from an on position corresponding to an on mode of the circuit breaker to an off position corresponding to an off mode of the circuit breaker. In response to the rotation of the switch, the rotary disk rotates with the switch. In response to the rotary disk rotating, the linkage assembly moves from a first position corresponding to the on mode of the circuit breaker to a second position corresponding to the off mode of the circuit breaker. In response to the linkage assembly moving from the first position to the second position, the set of moving contacts disengages from a set of stationary contacts. In response to the linkage assembly moving from the first position to the second position, the interlock component rotates from an aligned position to an unaligned position. In an unhealthy state of the circuit breaker, the switch rotates from the on position toward the off position. In the unhealthy state, at least one contact of the set of moving contacts is welded to one contact of the set of stationary contacts. In response to the rotation of the switch, the rotary disk rotates with the switch. In response to the at least one of the set of moving contacts being welded to the one of the set of stationary contacts, the linkage assembly remains in the first position, the set of moving contacts remains engaged with the set of stationary contacts, and the interlock component remains in the aligned position. As the switch rotates toward the off position, the interlocking hook of the interlock component engages with the receptacle of the rotary disk. In response to the interlocking hook engaging with the receptacle, the switch does not rotate past a trip position between the on position and the off position.

In yet another embodiment, a method of preventing a switch of a circuit breaker from being turned from an on position to an off position when contacts are welded together includes rotating the switch of the circuit breaker in a first direction from the on position toward the off position. The switch is coupled to a rotary disk having a receptacle configured to engage with an interlocking hook of an interlock component of the circuit breaker when the interlock component is in an aligned position. The method further includes, when the contacts are welded together, preventing the switch from being turned past an intermediary interlock position between the on position and the off position such that the switch cannot reach the off position. To prevent the switch from being turned past the intermediary interlock position, the circuit breaker stops rotation of the rotary disk by engaging the receptacle of the rotary disk with the interlocking hook of the interlock component and stops, via the interlocking hook, the rotary disk at a point of interlock. The point of interlock corresponds to the intermediary interlock position of the switch. The method further includes, when the contacts are not welded together, enabling the switch to be turned from the on position to the off position by moving, by the rotary disk, a linkage assembly coupled to the rotary disk in a direction that separates moving contacts of the contacts from stationary contacts of the contacts. The moving contacts are coupled to the linkage assembly. When the contacts are not welded together one or more springs pull a distal end of the interlock component coupled to the linkage assembly out of the aligned position to misalign the interlock component such that the interlocking hook does not engage with the receptacle of the rotary disk at the point of interlock.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example of an interlocking circuit breaker, according to some embodiments.

FIG. 2 illustrates an example of interlocking circuit breaker mechanisms, according to some embodiments.

FIGS. 3A-3C illustrate three different views of a circuit breaker in a closed position, according to some embodiments.

FIGS. 4A-4C illustrate three different views of a circuit breaker in an open position, according to some embodiments.

FIGS. 5A-5C illustrate three different views of a circuit breaker in an interlocked position due to contact welding, according to some embodiments.

FIGS. 6A-6C illustrate three positions of a circuit breaker switch on a circuit breaker faceplate, according to some embodiments.

FIG. 7 illustrates an example of a circuit, according to some embodiments.

### DETAILED DESCRIPTION

Various embodiments of the present technology generally relate to a safety feature of industrial circuit breakers. More specifically, a mechanism is disclosed that prevents a circuit breaker switch from being turned to the off position when circuit breaker contacts are welded. In an embodiment of the invention, a three-phase circuit breaker includes an interlock component that engages with a rotary disk coupled to a switch on the front of the device when contacts are welded together in the circuit breaker. In this manner, the interlock component prevents the rotary disk, and therefore the switch, from turning into the off position. Instead, the interlock component stops the rotary disk and switch from turning past a trip position. However, when no contact welds are present and the contacts are successfully opened, the interlock component rotates out of the way such that the rotary disk and switch can turn all the way to the off position.

A circuit breaker is a switching device that interrupts current during fault conditions or overload situations, thereby preventing damage caused by overcurrent. Many circuit breakers include thermal protection, magnetic protection, microprocessor protection, electronic protection, or a combination thereof. As one example, in a thermal-magnetic circuit breaker, magnetic protection is provided by an electromagnet that interrupts current nearly instantaneously when the electromagnetic force generated by the large current is strong enough, protecting the circuit from the dangers associated with large surges in current (i.e., short circuits). These surges in current are highly dangerous, both for humans and the system, and therefore must be interrupted quickly. Thermal protection, on the other hand, protects against lower value but longer-term overcurrent. Unlike magnetic protection, thermal protection does not cause the circuit breaker to trip immediately but rather provides a time-response that is inversely proportional to the value of the overcurrent-tripping the circuit breaker sooner for larger currents but allowing smaller overloads to persist for longer periods of time. Thermal protection is achieved with at least one bimetallic strip that deforms as temperature changes, resulting in a mechanical displacement that trips the circuit breaker.

When the circuit breaker is in a healthy state and experiences a short circuit or overload condition, a mechanical reaction in the device causes metal contacts in the device to open, thereby interrupting the circuit. This mechanical reaction leading to separation of the contacts is commonly achieved using mechanically stored energy contained within the circuit breaker, such as in springs or hydraulics, but may also be achieved by thermal expansion or a magnetic field. The circuit breaker contacts allow current to flow through the device and are made of highly conductive materials such as copper or silver, as just a few examples. When the circuit breaker trips or is turned off, the contact pairs are separated from one another and the flow of current stops.

However, contact erosion may occur over time, often due to continual overload or arcing across the gap when the contacts are first separated. Eventually, this contact erosion may result in metal migration such that the contacts become welded shut. Welds may occur on one or both sides of a given contact pair. When a weld occurs, it can be impossible to stop the flow of current, even when the circuit breaker is turned off. This welding scenario can be hazardous to operators or other users due to the fact that the circuit breaker could be turned to the off position, indicating that the electrical connection is open and no current is flowing, despite the fact that current is still flowing through the device due to the welded contacts. This can lead users to take action in reliance on the false belief that the circuit breaker is off resulting in damage to connected devices, electrocution, fires, and the like.

Thus, in an embodiment of the present technology, an industrial circuit breaker includes a small interlock component that interfaces with a rotary disk coupled to a handle or switch on the circuit breaker. The interlock component prevents the switch from being turned to the off position in a welded contact scenario. The interlock component and the rotary disk each include an undercut, or “hook” feature, such that they hook together under certain conditions, preventing the rotary disk from turning past the point of interlock. The interlock component is only engaged, however, when the circuit is closed and cannot be opened due to contact welding. Thus, if no contact welding is present and the switch is turned to the off position, a linkage assembly shifts out of the way of the interlock component's rotation and the circuit breaker opens properly. The linear motion of the linkage assembly due to separation of the contacts causes the interlock component to rotate out of the way (pulled by a spring) so as not to interfere with turning of the rotary disk. However, when contacts are welded, the interlock component does not move out of the way due to the fact that there is not enough linear motion of the linkage assembly because the contacts will not open. Thus, when the rotary disk is turned toward the off position, the interlock component will catch the undercut on the rotary disk, stopping its rotation at the point of interlock. In some embodiments, the switch has an intermediary interlock position that corresponds to the point of interlock-thereby informing users that the device is in a state of interlock.

Other remedies for the welded contacts issue exist but are far more complex and expensive to implement. For example, existing remedies often require many parts, some of which may be made of metal, that altogether serve to indicate to a user that a contact weld is present. However, these existing solutions are known to break or fail often, perhaps due to their many parts and complex arrangement. Existing solutions can also add significant weight to the circuit breaker and make the device more expensive. Thus, the present invention requires the addition of only a single part, the interlock component, which can be composed entirely of plastic-thereby making it much more cost-effective and adding only negligible weight to the circuit breaker.

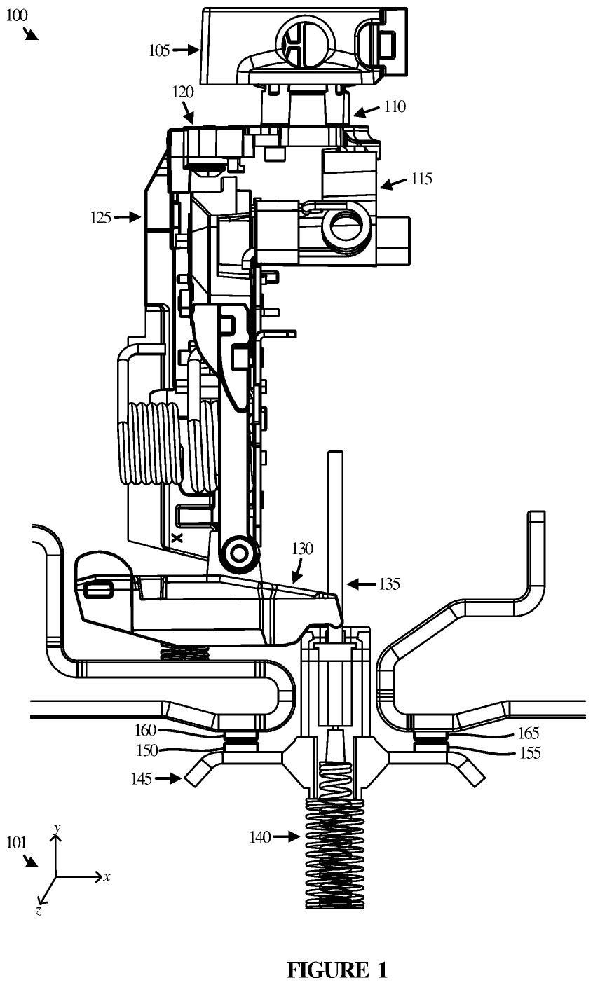

Moving on to the Figures, FIG. 1 illustrates system 100. System 100 is representative of a circuit breaker in which embodiments of the present technology may be implemented. System 100 may include, for example, a thermal-magnetic circuit breaker. FIG. 1 shows only a portion of the components that make up system 100 in accordance with the present disclosure. System 100 includes additional componentry, including an external cover, omitted from FIG. 1 for the sake of clarity. As shown in FIG. 1, system 100 includes switch 105, rotary disk 110, gearing component 115, housing 120, linkage assembly 125, rocker arm 130, plunging mechanism 135, plunging spring 140, switching element 145, moving contact 150, moving contact 155, stationary contact 160, and stationary contact 165. System 100 may include additional components as compared to what is shown in the example of FIG. 1 or may include fewer components than what is shown in FIG. 1. FIG. 1 further includes axes 101, in reference to which elements of FIG. 1 are described.

Switch 105 is a rotary switch on an outside surface of the circuit breaker that, in some examples, can be rotated between three positions: “ON,” “OFF,” and “TRIP.” In some examples, switch 105 rotates ninety degrees between “ON” and “OFF.” Switch 105 rotates about a first axis that runs through the center of the switch. The first axis is parallel to the y-axis. Switch 105 rotates in an x-z plane. Switch 105 is directly coupled to rotary disk 110 such that when switch 105 is rotated, rotary disk 110 also rotates. In some examples, switch 105 and rotary disk 110 may be described as a single component, given that they may be permanently affixed to one another in some embodiments. Thus, rotary disk 110 rotates simultaneously with switch 105 and about the same axis as switch 105. Rotary disk 110 also rotates in an x-z plane shifted in the −y direction from the x-z plane in which switch 105 rotates.

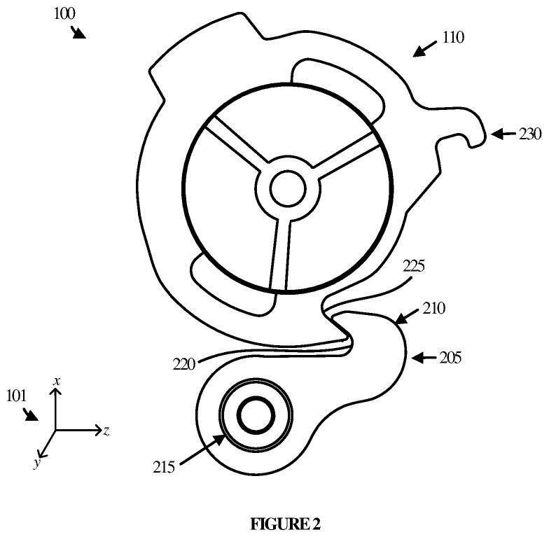

Rotary disk 110, as a result of being fixed to switch 105, rotary disk 110 also turns between the “ON” and the “OFF” position and may include the intermediary “TRIP” position. Although not visible in FIG. 1, rotary disk 110, in an embodiment of the present invention, includes a receptacle (see, e.g., FIG. 2, rotary disk receptacle 225) on its circumferential edge configured to interlock with a hook feature of an interlock component (see, e.g., FIG. 2, interlock component 205) in welded contacts scenarios. The interlock component, also not visible in FIG. 1, is housed in housing 120 and also rotates about an axis parallel to the y-axis in an x-z plane. The interlock component housing controls movement in at least one direction of the interlock component. The interlock component will be described in greater detail in reference to FIG. 2.

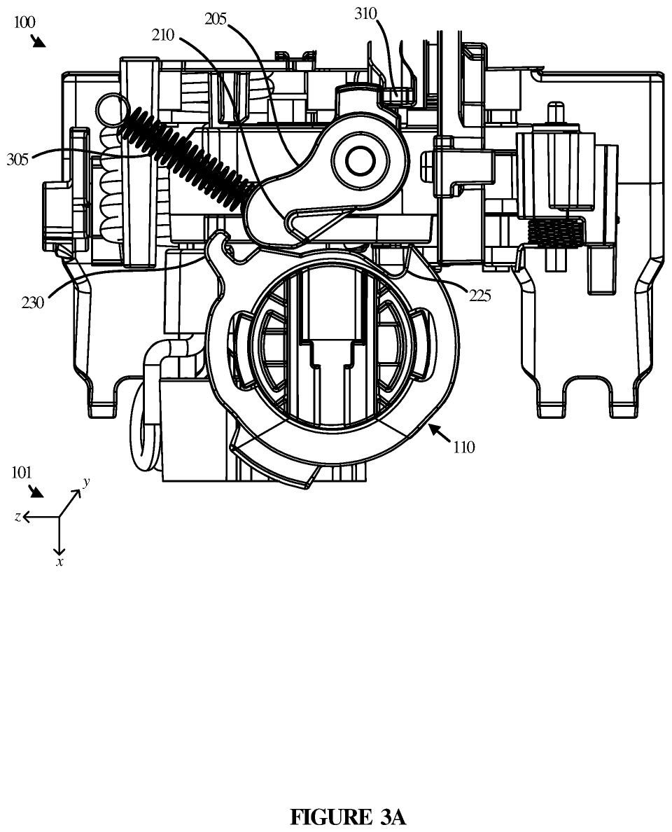

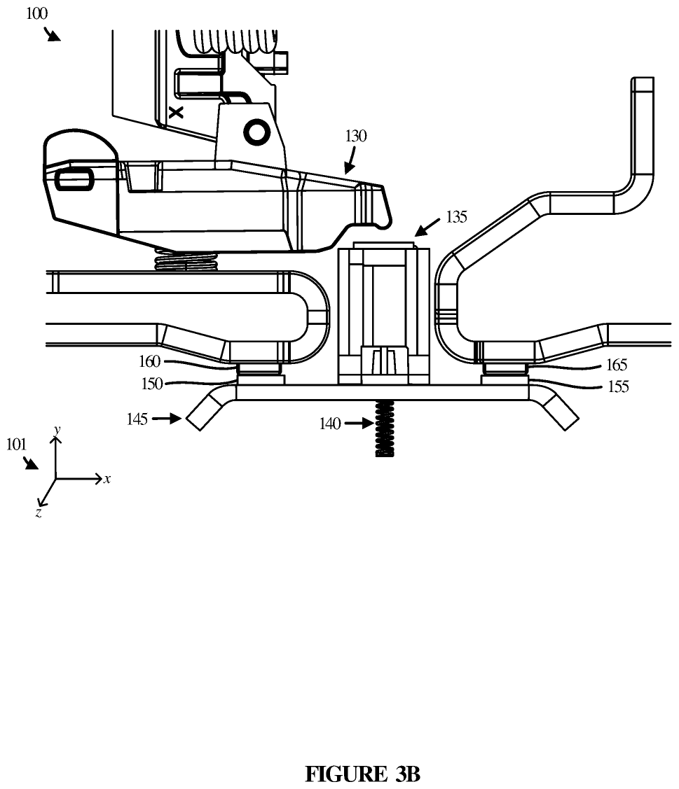

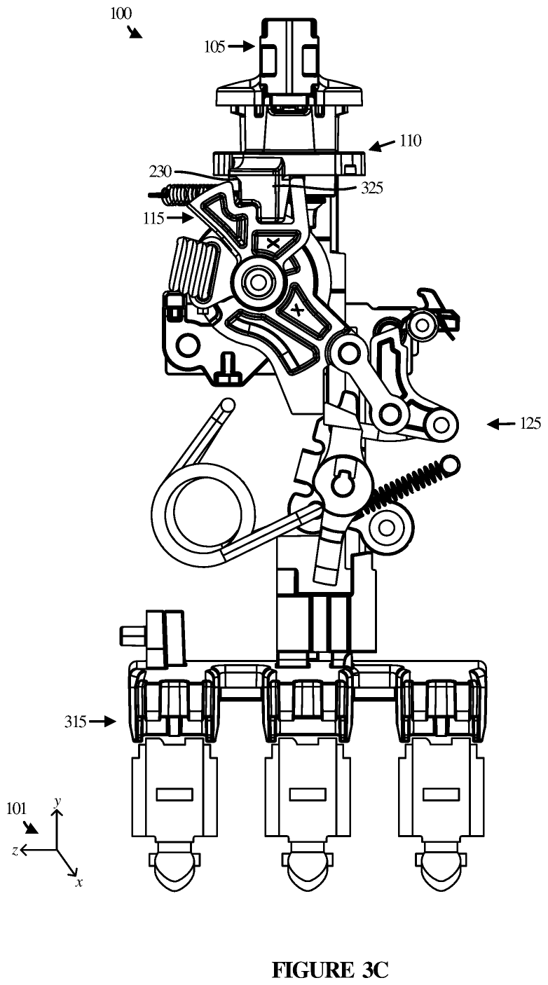

Rotary disk 110 further includes a gear interface (see, e.g., FIG. 2, gear interface 230) on its circumferential edge configured to interface with gearing component 115. The gear interface on the circumferential edge of rotary disk 110 protrudes from the edge of rotary disk 110 towards gearing component 115 (i.e., along the y-axis) and is configured to interface (i.e., engage) with a notch (see, e.g., FIG. 3C, notch 325) in gearing component 115 such that when rotary disk 110 rotates, the gear interface pushes gearing component 115 via the notch. Gearing component 115 includes one or more components that work together to translate rotation of rotary disk 110 to axial movement of linkage assembly 125 (i.e., along the y-axis of axes 101). In response to being pushed by the gear interface via the notch, one or more rotary components of gearing component 115 rotate about an axis parallel to the x-axis to translate the rotation to linkage assembly 125.

As described, gearing component 115 translates the rotation of rotary disk 110 to axial movement of linkage assembly 125. Gearing component 115 contacts a proximal end of linkage assembly 125 (i.e., the end nearest to rotary disk 110, in the +y direction). Linkage assembly 125 includes a plurality of moving components including rocker arm 130, but in whole shifts along the y-axis to open and close the circuit breaker via rocker arm 130. Rocker arm 130 is located on a distal end of linkage assembly 125 (i.e., the end farthest from rotary disk 110, in the −y direction). When linkage assembly 125 is pushed in the −y direction by gearing component 115 linkage assembly 125 uses rocker arm 130 to open the circuit breaker's contacts.

Rocker arm 130, in the present example, is a linear device that pivots about a rear axis (i.e., at the −x end of rocker arm 130). Rocker arm 130 is coupled to linkage assembly 125 on a first side of rocker arm 130 and a spring on a second side of rocker arm 130. Thus, when linkage assembly 125 shifts in the −y direction in response to switch 105 being turned toward the “OFF” position, rocker arm 130 is pushed in the −y direction (pivoting about the read end) such that a front end (i.e., the end farthest in the +x direction) pushes plunging mechanism 135 in the −y direction as well. As the front end of rocker arm 130 shifts in the −y direction, the spring coupled to rocker arm 130 is compressed. Alternatively, when linkage assembly 125 shifts in the +y direction in response to switch 105 being turned toward the “ON” position, rocker arm 130 moves in the +y direction as a result of being pulled by linkage assembly 125 and/or being pushed by the spring coupled to rocker arm 130. As a result, plunging mechanism 135 is freed to move in the +y direction, driven by plunging spring 140.

As mentioned, plunging mechanism 135, in response to being pushed by rocker arm 130, moves axially in the −y direction. Plunging mechanism 135 is coupled to plunging spring 140, which compresses in response to plunging mechanism 135 being pushed in the −y direction by rocker arm 130. Plunging mechanism 135 includes switching element 145. Switching element 145 is affixed to plunging mechanism 135 such that switching element 145 moves axially (along the y-axis) with plunging mechanism 135 when plunging mechanism 135 moves. Switching element 145 is comprised of two arms affixed to and extending laterally from plunging mechanism 135 in an x-z plane. Switching element 145 includes the moving contacts that separate from the stationary contacts to open the circuit breaker. Thus, moving contact 150 and moving contact 155 are each affixed to switching element 145 such that they move axially with switching element 145 and plunging mechanism 135. Thus, when the circuit breaker is turned off (i.e., opened), switching element, along with moving contact 150 and moving contact 155, shifts in the −y direction in response to plunging mechanism 135 being pushed in the −y direction by rocker arm 130 to separate moving contact 150 from stationary contact 160 and moving contact 155 stationary contact 165. Alternatively, when the circuit breaker is turned on (i.e., closed), switching element 145, along with moving contact 150 and moving contact 155, shift in the +y direction in response to plunging mechanism 135 being pushed in the +y direction by plunging spring 140 to bring moving contact 150 into contact with stationary contact 160 and moving contact 155 into contact with stationary contact 165.

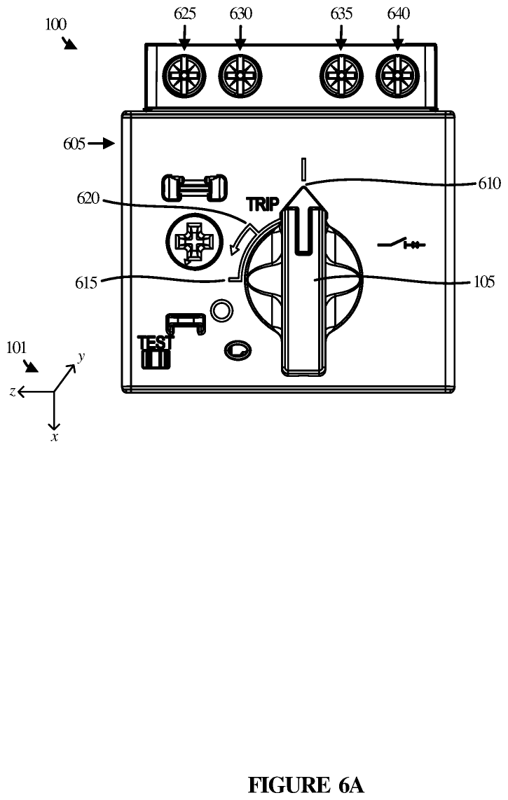

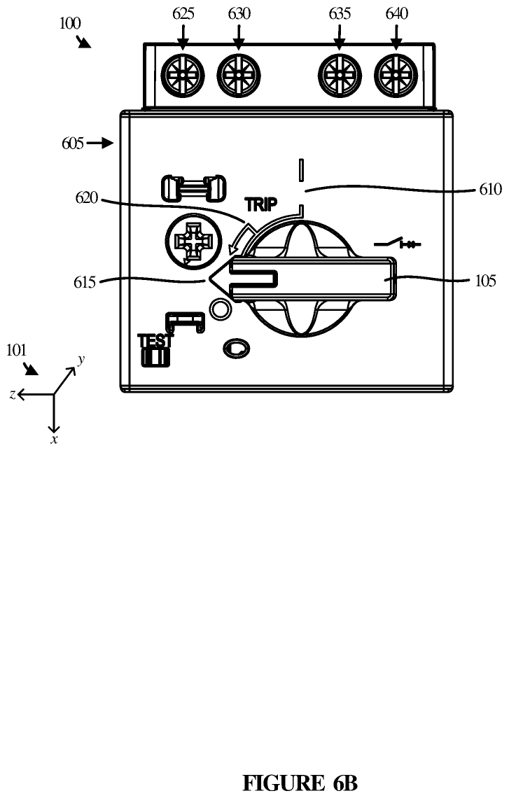

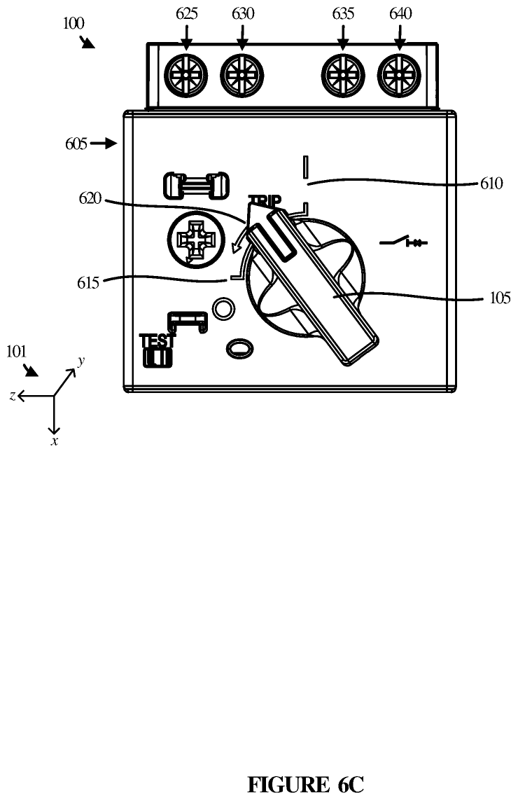

In summary, when system 100, while in a healthy state, is turned from the “ON” position to the “OFF” position (i.e., when the circuit breaker is opened), switch 105 is rotated counterclockwise (see, e.g., FIGS. 6A-6C) in an x-z plane on an external faceplate of the circuit breaker (see, e.g., FIGS. 6A-6C, switching faceplate 605). In response, rotary disk 110 also rotates from the “ON” position to the “OFF” position counterclockwise in an x-z plane, beneath the external faceplate of the circuit breaker. As rotary disk 110 rotates counterclockwise, a gear interface (e.g., gear interface 230) pushes gearing component 115, which translates the rotary motion of rotary disk 110 and switch 105 to axial movement of linkage assembly 125. Linkage assembly 125 shifts in the −y direction to push rocker arm 130, which pushes plunging mechanism 135 in the −y direction. As plunging mechanism 135 moves in the −y direction, plunging spring 140 is compressed and switching element 145 also moves in the −y direction, separating the moving contacts (i.e., moving contact 150 and moving contact 155) from the stationary contacts (i.e., stationary contact 160 and stationary contact 165) and opening the circuit breaker.

In the reverse, when system 100 is turned from the “OFF” position to the “ON” position (i.e., when the circuit breaker is closed), switch 105 is rotated clockwise (see, e.g., FIGS. 6A-6B) in an x-z plane on the external faceplate of the circuit breaker. In response, rotary disk 110 also rotates from the “OFF” position to the “ON” position clockwise in an x-z plane, beneath the external faceplate of the circuit breaker. As rotary disk 110 rotates clockwise, a gear interface (e.g., gear interface 230) pushes gearing component 115, which translates the rotary motion of rotary disk 110 and switch 105 to axial movement of linkage assembly 125. Linkage assembly 125 shifts in the +y direction to release and/or raise rocker arm 130, which releases plunging mechanism 135 to move in the +y direction as it is pushed by extension of plunging spring 140. As plunging mechanism 135 moves in the +y direction, switching element 145 also moves in the +y direction, bringing the moving contacts (i.e., moving contact 150 and moving contact 155) back into physical contact with the stationary contacts (i.e., stationary contact 160 and stationary contact 165), thereby closing the circuit breaker.

In embodiments of the present technology, various components of system 100 are comprised of metal, plastic, or both. For example, in an exemplary embodiment, switch 105, rotary disk 110, gearing component 115, and rocker arm 130 are all made of plastic. Additionally, some or all of the components that make up linkage assembly 125 may be made of plastic.

FIG. 2 illustrates the interlocking mechanisms of system 100 in accordance with some embodiments of the present technology. FIG. 2 only includes a portion of the componentry that would make up system 100 in accordance with the present disclosure. System 100, as shown in FIG. 2, includes rotary disk 110 and interlock component 205. Interlock component 205 includes interlocking hook 210 and rotary element 215. Interlocking hook 210 includes hook receptacle 220. Rotary disk 110 includes rotary disk receptacle 225. System 100 may include fewer or additional interlocking mechanisms as compared to what is shown in the example of FIG. 2. FIG. 2 further includes axes 101, in reference to which elements of FIG. 2 are described.

As explained in reference to FIG. 1, rotary disk 110, in some embodiments, is directly coupled to switch 105 such that when switch 105 is rotated, rotary disk 110 also rotates. In some examples, switch 105 and rotary disk 110 may be described as a single component, given that they may be permanently affixed to one another or comprised of a single piece of material in certain embodiments. Thus, rotary disk 110 rotates simultaneously with switch 105 and about the same axis as switch 105. Rotary disk rotates in an x-z plane. Rotary disk 110, as a result of being fixed to switch 105, also turns between the “ON” and the “OFF” position and may include the intermediary “TRIP” position.

Rotary disk 110, an embodiment of the present invention, includes rotary disk receptacle 225 on its circumferential edge configured to form an interlock with interlocking hook 210 of interlock component 205 in welded contacts scenarios. Interlocking hook 210, when in an aligned position, catches rotary disk receptacle 225 as it rotates counterclockwise. The circumferential edge of rotary disk 110 fits into hook receptacle 220 as shown in FIG. 2. Interlock component 205 pivots in an x-z plane about an axis through the center of rotary element 215. The axis about which interlock component 205 pivots is parallel to the y-axis. Interlocking hook 210 extends from a circumferential edge of a circular body of interlock component 205. The circular body is concentric to rotary element 215. In certain embodiments, interlock component 205 is housed in housing 120 from FIG. 1.

In at least one embodiment, interlocking hook 210 is coupled to one or more springs (see, e.g., FIG. 3, interlock spring 305) that pull interlocking hook 210 out of the aligned state and into a misaligned state (i.e., away from rotary disk 110) when the circuit breaker is in a healthy state (i.e., no contact welds). The one or more springs pull interlocking hook 210 in the x-z plane in which interlock component 205 rotates such that interlock component 205 rotates about rotary element 215 in response to being pulled by the one or more springs. Additionally, the rotary (or proximal) end of interlock component 205 (i.e., the end including the circular body and rotary element 215) interfaces with an extension component (e.g., extension component 310, FIG. 3) on the proximal end of linkage assembly 125 such that the extension component of linkage assembly 125 prevents interlock component 205 from being pulled out of the way of rotary disk 110 when linkage assembly 125 is in an aligned position (i.e., aligned with interlock component 205). Thus, interlocking hook 210 will catch rotary disk receptacle 225 as rotary disk 110 rotates towards the “OFF” position when the circuit breaker is in an unhealthy state (i.e., welded contacts) because linkage assembly 125 is stuck in the aligned position. However, when the circuit breaker is in a healthy state (i.e., no welded contacts), linkage assembly 125 can successfully move into the unaligned position and the extension component no longer prevents interlock component 205 from rotating away from rotary disk 110 in response to the pull of the one or more springs coupled to interlock component 205.

In FIG. 2, rotary disk 110 is in the “TRIP” position which corresponds to switch 105 from FIG. 1 being in the “TRIP” position. The “TRIP” position is an intermediate position between “ON” and “OFF.” When switch 105 and rotary disk 110 are rotated from the “ON” position toward the “OFF” position, rotary disk 110 (and switch 105) are stopped at the “TRIP” position by interlock component 205 when contact welding has occurred in the circuit breaker such that an operator or other user cannot turn switch 105 all the way to “OFF.” Thus, when contact welding has occurred, switch 105 and rotary disk 110 can only be turned between “ON” and “TRIP.”

In operation, if a circuit breaker of which system 100 is representative is in the “ON” position (i.e., contacts closed), a user may try to turn the circuit breaker off. However, if any contacts are welded together, rocker arm 130 from FIG. 1 will not be able to push plunging mechanism 135 in the −y direction because a moving contact (e.g., moving contact 150) has welded to a stationary contact (e.g., stationary contact 160). Because rocker arm 130 cannot open the contacts, it will stop at the point where it contacts plunging mechanism 135. Linkage assembly 125, therefore, will not be able to move into the unaligned position because rocker arm 130 is preventing further movement in the −y direction. As a result, linkage assembly 125, or an extension component thereof, will prevent interlock component 205 from pivoting out of the way of rotary disk 110.

Thus, when the user tries to turn the circuit breaker off, rotary disk 110 will begin to rotate counterclockwise in the x-z plane but will be stopped by interlock component 205 when interlocking hook 210 catches rotary disk receptacle 225 at the point of interlock. The point of interlock corresponds to the “TRIP” position on the circuit breaker.

Alternatively, if a user of the circuit breaker of which system 100 is representative tries to turn the circuit breaker off when no contact welds are present, rocker arm 130 will be able to push plunging mechanism 135 in the −y direction so that the moving contacts separate from the stationary contacts. Linkage assembly 125, therefore, will shift in the −y direction to its unaligned position, thereby freeing interlock component 205 to pivot away from rotary disk 110 into its unaligned position as it is pulled by the one or more springs. Thus, the user is able to successfully turn switch 105 and rotary disk 110 all the way into the “OFF” position.

When system 100 is in an unhealthy state due to contact welding, rotation of switch 105 may apply a force on interlocking hook 210 of interlock component 205 from the rotation of rotary disk 110 by an operator or other user. However, in some embodiments of the present technology, interlock component 205 is comprised of plastic and can withstand a force of up to three- and one-half Newton-meters (3.5 Nm) before failing. Upon failing, switch 105 rotates to the “OFF” position and at least one moving contact remains welded to one stationary contact such that current continues to flow.

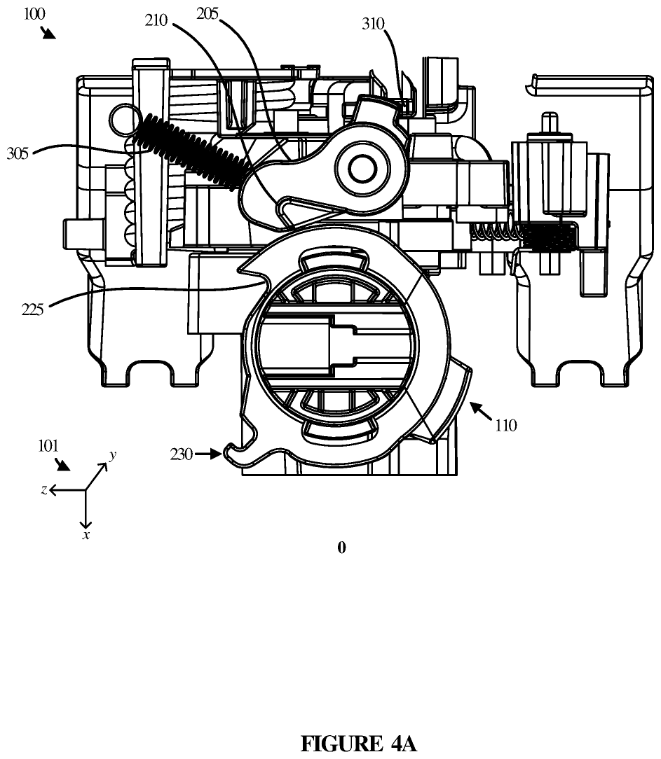

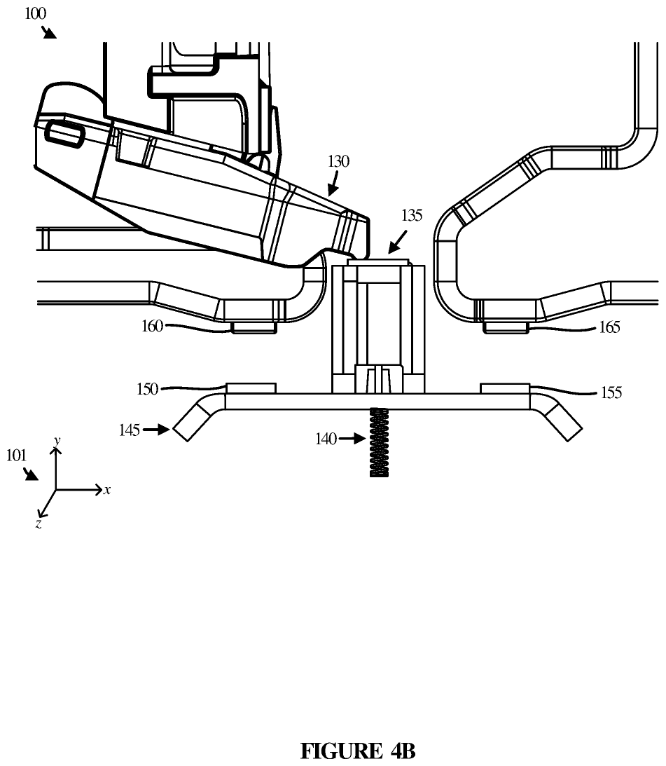

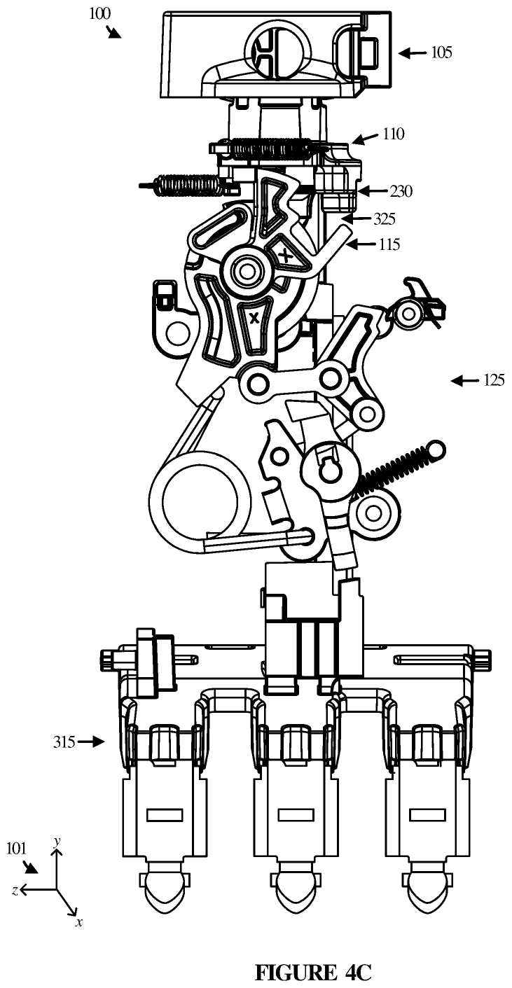

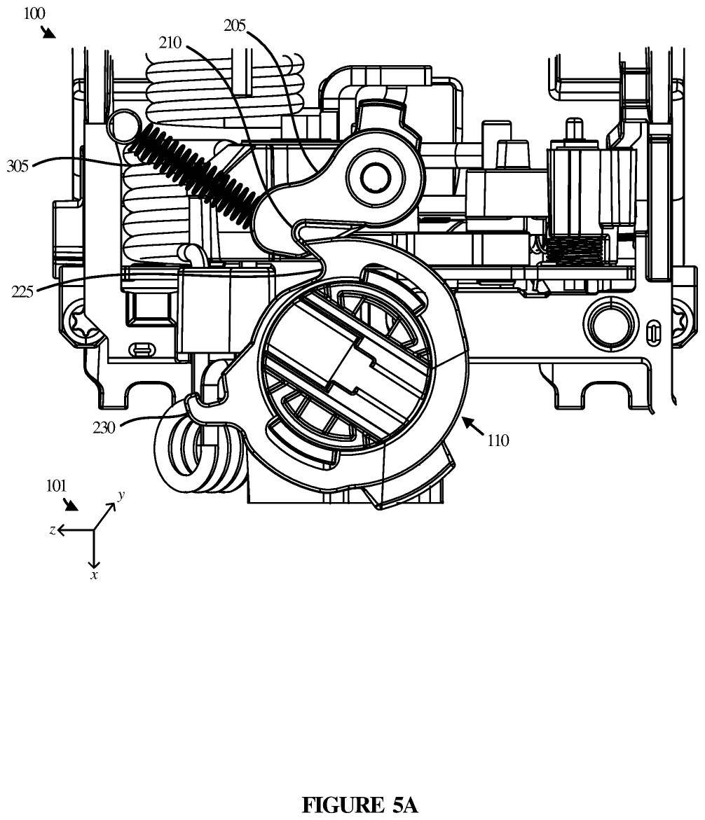

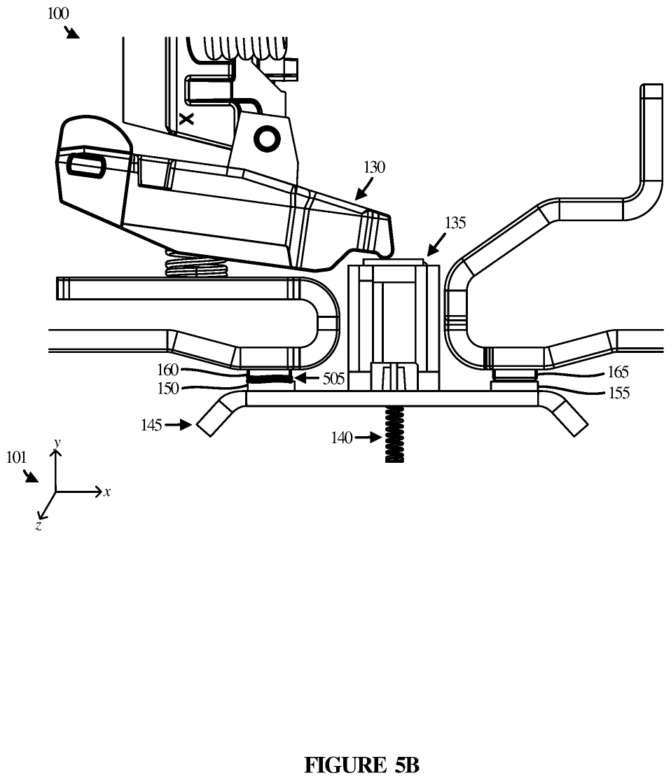

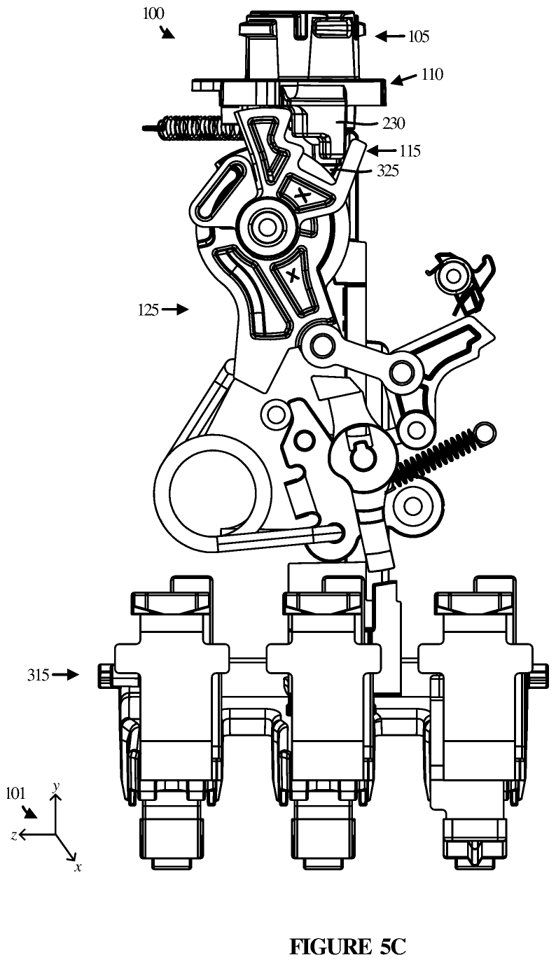

FIGS. 3A-3C illustrate three different views of system 100 in the “ON” position. FIGS. 4A-4C illustrate the same three views of system 100 in the “OFF” position. FIG. 5A-5C illustrate the same three views of system 100 in the “TRIP” position. System 100 may include fewer or additional components as compared to what is shown in the examples of FIGS. 3A-5C.

FIG. 3A illustrates a first view of system 100. In the example of FIGS. 3A-3C, system 100 is turned on such that switch 105 is turned to the “ON” position, the stationary contacts and moving contacts are in contact with each other, and current is flowing through the circuit breaker. The first view of system 100 as shown in FIG. 3A includes rotary disk 110, interlock component 205, interlock spring 305, and extension component 310. Rotary disk 110 includes rotary disk receptacle 225 and gear interface 230. Interlock component 205 includes interlocking hook 210. FIG. 3A further includes axes 101, in reference to which elements of FIG. 3A are described.

As previously described, when rotary disk 110 is in the “ON” position, linkage assembly 125 is in the aligned position such that interlock component 205 is also held in its aligned position by extension component 310. Extension component 310 is coupled to the proximal (i.e., +y) end of linkage assembly 125 and may be molded into the same part as linkage assembly 125. In some embodiments, extension component 310 may be an independent component coupled to linkage assembly 125. In the aligned position, interlock component 205 is positioned near to rotary disk 110 such that it is positioned to catch rotary disk receptacle 225 if rotary disk 110 begins to turn toward the “OFF” position. Thus, linkage assembly 125, or, more specifically, extension component 310, prevents interlock spring 305 from pulling interlocking hook 210 of interlock component 205 away from rotary disk 110 so that rotary disk 110 can rotate freely. Interlock spring 305 is coupled to interlock component 205 via a back side of interlocking hook 210 such that, when linkage assembly 125 is in the unaligned position, interlocking hook 210 is pulled toward interlock spring 305 and away from rotary disk 110.

FIG. 3B illustrates a second view of system 100 in the “ON” position. The second view of system 100 as shown in FIG. 3B includes rocker arm 130, plunging mechanism 135, plunging spring 140, switching element 145, moving contact 150, moving contact 155, stationary contact 160, and stationary contact 165. FIG. 3B further includes axes 101, in reference to which elements of FIG. 3B are described.

In system 100 as shown in FIG. 3B, rocker arm 130 is not in contact with plunging mechanism 135. Thus, plunging spring 140 is expanded such that switching element 145 is moved in the +y direction to where the moving contacts are touching the stationary contacts. Thus, moving contact 150 is in contact with stationary contact 160 and moving contact 155 is in contact with stationary contact 165. As previously mentioned, this positioning corresponds to the circuit breaker (of which system 100 is representative) being closed. When the circuit breaker is closed, current is flowing through the circuit breaker and switch 105 is turned to “ON.”

FIG. 3C illustrates a third view of system 100 in the “ON” position. The third view of system 100, as shown in FIG. 3C, includes switch 105, rotary disk 110, gear interface 230, notch 325, gearing component 115, linkage assembly 125, and contact housing 315. FIG. 3C further includes axes 101, in reference to which elements of FIG. 3C are described. In system 100 as shown in FIG. 3C, switch 105 is turned to the “ON” position and rotary disk 110 is therefore also in the “ON” position. Gear interface 230 is positioned inside of notch 325 in gearing component 115. Gearing component 115 is therefore also in its corresponding “ON” position, which translates to linkage assembly 125 being in its aligned position as shown in FIG. 3A.

Contact housing 315, as shown in FIG. 3C, includes three sets of plunging mechanisms and associated contacts. Thus, in each of the three legs of contact housing 315, there is at least one set of moving contacts and at least one set of stationary contacts. Contact welding, as described in reference to the present disclosure, may occur within any of the sets of contacts included in contact housing 315.

FIG. 4A illustrates the first view of system 100. In the example of FIG. 4A-4C, system 100 is off such that switch 105 is turned to the “OFF” position, the stationary contacts and moving contacts are separated from each other, and current is not flowing through the circuit breaker. The first view of system 100, as shown in FIG. 4A, includes rotary disk 110, interlock component 205, interlock spring 305, and extension component 310. Rotary disk 110 includes rotary disk receptacle 225 and gear interface 230. Interlock component 205 includes interlocking hook 210. FIG. 4A further includes axes 101, in reference to which elements of FIG. 4A are described.

As previously described, when rotary disk 110 is in the “OFF” position, linkage assembly 125 is not in its aligned position such that interlock component 205 is free to be pivoted away from rotary disk 110 by interlock spring 305. Thus, in FIG. 4A it can be seen that interlock spring 305 is compressed and has pulled interlocking hook 210 of interlock component 205 away from rotary disk 110 such that rotary disk receptacle 225 did not catch interlocking hook 210 as is rotated counterclockwise from the “ON” position to the “OFF” position.

In the aligned position, interlock component 205 is positioned near to rotary disk 110 such that it is positioned to catch rotary disk receptacle 225 if rotary disk 110 begins to turn towards the “OFF” position. Thus, linkage assembly 125, or, more specifically, extension component 310, prevents interlock spring 305 from pulling interlocking hook 210 of interlock component 205 away from rotary disk 110 so that rotary disk 110 can rotate freely. Interlock spring 305 is coupled to interlock component 205 via a back side of interlocking hook 210 such that, when linkage assembly 125 is in the unaligned position (i.e., shifted in the −y direction), interlocking hook 210 is pulled toward interlock spring 305 and away from rotary disk 110.

FIG. 4B illustrates the second view of system 100 in the “OFF” position. The second view of system 100, as shown in FIG. 4B, includes rocker arm 130, plunging mechanism 135, plunging spring 140, switching element 145, moving contact 150, moving contact 155, stationary contact 160, and stationary contact 165. FIG. 4B further includes axes 101, in reference to which elements of FIG. 4B are described.

In system 100, as shown in FIG. 4B, rocker arm 130 is in contact with plunging mechanism 135 and has pushed plunging mechanism 135 in the −y direction, compressing plunging spring 140. As a result, moving contact 150 and moving contact 155 are separated, via the switching element, from stationary contact 160 and stationary contact 165, respectively. As previously mentioned, this positioning corresponds to the circuit breaker, of which system 100 is representative, being open. When the circuit breaker is open, no contacts are welded together and current is not flowing through the circuit breaker. Switch 105 is also correspondingly in the “OFF” position.

FIG. 4C illustrates the third view of system 100 in the “OFF” position. The third view of system 100, as shown in FIG. 4C, includes switch 105, rotary disk 110, gear interface 230, notch 325, gearing component 115, linkage assembly 125, and contact housing 315. FIG. 4C further includes axes 101, in reference to which elements of FIG. 4C are described. In system 100 as shown in FIG. 4C, switch 105 is turned to the “OFF” position and rotary disk 110 is therefore also in the “OFF” position. Gear interface 230 has rotated into the “OFF” position with rotary disk 110. As a result of gear interface 230 rotating, at least one component of gearing element 115 has rotated clockwise in response to gear interface 230 pushing gearing component 115 via notch 325. In response to such rotation of gearing component 115, linkage assembly 125 has moved out of its aligned position and into its unaligned position. In the unaligned position of linkage assembly 125, linkage assembly 125 is shifted in the −y direction compared to its aligned position in FIG. 3C, thereby causing rocker arm 130 to separate the moving contacts from the stationary contacts.

Contact housing 315, as shown in FIG. 4C, includes three sets of plunging mechanisms and associated contacts. Thus, in each of the three legs of contact housing 315, there is at least one set of moving contacts and at least one set of stationary contacts. Contact welding, as described in reference to the present disclosure, may occur among any of the sets of contacts included in contact housing 315. In the present example, no contact welding is present in the circuit breaker, as evidenced by the −y movement of linkage assembly 125 into the unaligned position and switch 105 being turned fully into the “OFF” position.

FIG. 5A illustrates the first view of system 100. In the example of FIGS. 5A-5C, system 100 has at least one contact weld present. Therefore, in response to an attempt to open the circuit breaker, switch 105 can only be turned to the “TRIP” position because the stationary contacts and moving contacts were unable to separate from each other. Because of the contact weld, current is still flowing through the circuit breaker despite the fact that a user has tried to turn the circuit breaker off. The first view of system 100, as shown in FIG. 5A, includes rotary disk 110, interlock component 205, and interlock spring 305. Rotary disk 110 includes rotary disk receptacle 225 and gear interface 230. Interlock component 205 includes interlocking hook 210. FIG. 5A further includes axes 101 in reference to which elements of FIG. 5A are described.

In FIG. 5A, rotary disk 110 is turned to the intermediary “TRIP” position. In this position, interlock component 205 is in interlock with rotary disk 110. More specifically, interlocking hook 210 is hooked on rotary disk receptacle, preventing rotary disk from being turned counterclockwise any further toward “OFF.” In this state, interlock spring 305 is extended and linkage assembly 125 is in its aligned position, preventing interlock component 205 from being pivoted away from rotary disk 110 by interlock spring 305. As previously described, when rotary disk 110 is in the “TRIP” position, linkage assembly 125 cannot move out of its aligned position such that interlock component 205 cannot be pivoted away from rotary disk 110 by interlock spring 305.

In the aligned position, interlock component 205 is positioned near to rotary disk 110 such that it is positioned to catch rotary disk receptacle 225 if rotary disk 110 begins to turn towards the “OFF” position. Thus, linkage assembly 125, or extension component 310 on proximal (i.e., +y) end thereof, prevents interlock spring 305 from pulling interlocking hook 210 of interlock component 205 away from rotary disk 110 so that rotary disk 110 can rotate freely. Interlock spring 305 is coupled to interlock component 205 via a back side of interlocking hook 210 such that, when linkage assembly 125 is in the unaligned position, interlocking hook 210 is pulled towards interlock spring 305 and away from rotary disk 110.

FIG. 5B illustrates the second view of system 100 in the “TRIP” position. The second view of system 100, as shown in FIG. 5B, includes rocker arm 130, plunging mechanism 135, plunging spring 140, switching element 145, moving contact 150, moving contact 155, stationary contact 160, stationary contact 165, and contact weld 505. FIG. 5B further includes axes 101, in reference to which elements of FIG. 5B are described. In system 100, as shown in FIG. 5B, rocker arm 130 is in contact with plunging mechanism 135, but, due to contact weld 505, the moving contacts are not separated from the stationary contacts, plunging mechanism 135 is not shifted in the −y direction, and plunging spring 140 is extended. As previously mentioned, this positioning corresponds to the circuit breaker, of which system 100 is representative, being in interlock. When the circuit breaker is in interlock, current is flowing through the device and switch 105 is turned to “TRIP.”

In the example of FIG. 5B, moving contact 155 is in contact with stationary contact 165 without a contact weld present, but moving contact 150 is welded to stationary contact 160 via contact weld 505. Contact weld 505 prevents switching element 145 from moving the contacts apart. Contact weld 505 may be caused by contact erosion that occurs over time or in response to a particular event. Contact erosion may be due to continual overload or arcing across the gap when contacts are first separated. This contact erosion may result in metal migration such that the contacts become welded shut. Welds may occur on one or both sides of a given contact pair.

FIG. 5C illustrates a third view of system 100 in the “TRIP” position. The third view of system 100, as shown in FIG. 5C, includes switch 105, rotary disk 110, gear interface 230, notch 325, gearing component 115, linkage assembly 125, and contact housing 315. FIG. 5C further includes axes 101, in reference to which elements of FIG. 5C are described. In system 100 as shown in FIG. 5C, switch 105 is turned to the “TRIP” position and rotary disk 110 is therefore also in the “TRIP” position. Gear interface 230 has rotated into the “TRIP” position with rotary disk 110. As a result of gear interface 230 rotating, at least one component of gearing element 115 has rotated clockwise in response to gear interface 230 pushing gearing component 115 via notch 325. However, interlock component 205 has prevented rotary disk 110 from turning past the “TRIP” position, as shown in FIG. 5A. Thus, gear interface 230 and gearing component 115 cannot turn any further clockwise. Because gearing component 115 cannot turn any further clockwise, it will not translate to enough axial motion of linkage assembly 125 to move it out of alignment with interlock component 205. Because gearing component 115 is partially rotated, however, some axial motion of linkage assembly 125 may occur, but not enough to shift linkage assembly 125 into the unaligned position and allow interlock component 205 to pivot freely as it is pulled by interlock spring 305.

Contact housing 315, as shown in FIG. 5C, includes three sets of plunging mechanisms and associated contacts. Thus, in each of the three legs of contact housing 315, there is one set of moving contacts and one set of stationary contacts. Contact welding, as described in reference to the present disclosure, may occur among any of the three sets of contacts included in contact housing 315. In the present example, contact weld 505 exists between moving contact 150 and stationary contact 160, which are representative of any set of contacts within contact housing 315.

FIG. 6A illustrates switching faceplate 605 of system 100 in accordance with some embodiments of the present technology. Switching faceplate 605 includes switch 105, “ON” position 610, “OFF” position 615, “TRIP” position 620, auxiliary port 625, auxiliary port 630, auxiliary port 635, and auxiliary port 640. System 100 may include fewer or additional components as compared to what is shown in the example of FIG. 6A. FIG. 6A further includes axes 101, in reference to which elements of FIG. 6A are described.

In the example of FIG. 6A, switch 105 is rotated to “ON” position 610. As previously described, when switch 105 is turned to “ON” position 610, rotary disk 110 is also rotated to its corresponding “ON” position. When in the “ON” position, linkage assembly 125 is in its aligned position, the moving contacts (e.g., moving contact 150 and moving contact 155) are in contact with the stationary contacts (e.g., stationary contact 160 and stationary contact 165), and current is flowing through the circuit breaker. Thus, in some embodiments, the state of switching faceplate 605 as shown in FIG. 6A corresponds to the state of system 100 in FIGS. 3A-3C.

FIG. 6B illustrates switching faceplate 605 of system 100 in accordance with some embodiments of the present technology. Switching faceplate 605 includes switch 105, “ON” position 610, “OFF” position 615, “TRIP” position 620, auxiliary port 625, auxiliary port 630, auxiliary port 635, and auxiliary port 640. System 100 may include fewer or additional components as compared to what is shown in the example of FIG. 6B. FIG. 6B further includes axes 101, in reference to which elements of FIG. 6B are described.

In the example of FIG. 6B, switch 105 is rotated to “OFF” position 615. As previously described, when switch 105 is turned to “OFF” position 615, rotary disk 110 is also rotated to its corresponding “OFF” position. When in the “OFF” position, linkage assembly 125 is no longer in its aligned position, the moving contacts (e.g., moving contact 150 and moving contact 155) are separated from the stationary contacts (e.g., stationary contact 160 and stationary contact 165), and current is not flowing through the circuit breaker. Thus, in some embodiments, the state of switching faceplate 605 as shown in FIG. 6B corresponds to the state of system 100 in FIG. 4A-4C.

FIG. 6C illustrates switching faceplate 605 of system 100 in accordance with some embodiments of the present technology. Switching faceplate 605 includes switch 105, “ON” position 610, “OFF” position 615, “TRIP” position 620, auxiliary port 625, auxiliary port 630, auxiliary port 635, and auxiliary port 640. System 100 may include fewer or additional components as compared to what is shown in the example of FIG. 6C. FIG. 6C further includes axes 101, in reference to which elements of FIG. 6C are described.

In the example of FIG. 6C, switch 105 is rotated to “TRIP” position 620. As previously described, when switch 105 is turned to “TRIP” position 620, rotary disk 110 is also rotated to the “TRIP” position. Switch 105 may, when no contact welds are present, be turned into “TRIP” position 620 momentarily as it is being rotated between “ON” position 610 and “OFF” position 615. However, in contact welding scenarios, switch 105 cannot be turned past “TRIP” position 620 when it is turned toward “OFF” position 615 from “ON” position 610.

When switch 105 is stopped from rotating to “OFF” position 615 by interlock component 205, contact welding has occurred. Thus, when in “TRIP” position 615, linkage assembly 125 has not shifted into its unaligned position and prevents interlock component 205 from pivoting away from rotary disk 110. Additionally, the moving contacts (e.g., moving contact 150 and moving contact 155) are in contact with the stationary contacts (e.g., stationary contact 160 and stationary contact 165), and current is flowing through the circuit breaker. Thus, in some embodiments, the state of switching faceplate 605 as shown in FIG. 6C corresponds to the state of system 100 in FIGS. 5A-5C.

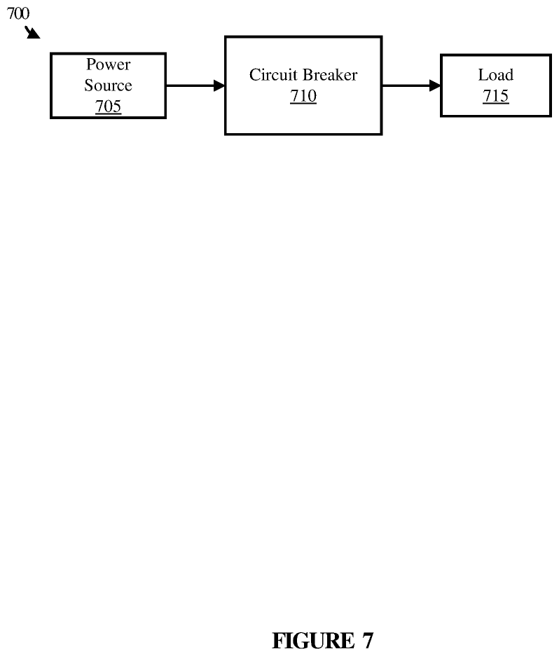

FIG. 7 illustrates circuit 700 in which a circuit breaker in accordance with the present disclosure may be implemented. Circuit 700 includes power source 705, circuit breaker 710, and load 715. Circuit 700 may include fewer or additional components as compared to what is shown in the example of FIG. 7.

Power source 705 is representative of any device or electrical component delivering power into circuit 700. Power source 705 may be an independent voltage source, a dependent voltage source, or other type of voltage source. Examples of such power sources include generators, photovoltaic cells, thermopiles, primary-cell batteries, a power grid, and the like. Power source 705 creates electrical voltage that causes current to flow through circuit 700 via one or more connecting wires or other connection components. Load 715 is representative of any device or electrical component that consumes electrical energy. Load 715 may represent a resistive load, inductive load, capacitive load, or combined load. Examples of loads include electric lamps, air conditioners, motors, resistors, heaters, processors, precision manufacturing equipment, data servers, pumps, fans, generators, robotic machinery, industrial automation controllers, and the like. Circuit breaker 710 is representative of any circuit breaker in accordance with the technology disclosed herein. For example, circuit breaker 710 may be representative of system 100 from the preceding figures. Circuit breaker 710 may alternatively be representative of a circuit breaker system that differs from system 100 but nonetheless includes interlock component 205 or a similar component that operates in a similar manner to interlock component 205.

In accordance with the example of FIG. 7, current flows from power source 705 to load 715. Circuit breaker 710 protects circuit 700, including power source 705 and load 715, by stopping the flow of current in cases of short circuit or overload. Thus, in accordance with the present disclosure, circuit breaker 710 is a circuit breaker that may include, for example, thermal tripping elements, magnetic tripping elements, microprocessor tripping elements, electronic tripping elements, or a combination thereof. Circuit breaker 710 further includes one or more interlocking mechanisms, such as interlock component 205 from the preceding figures, configured to prevent circuit breaker 710 from being turned off when a contact weld is present. In normal operation (i.e., when no contact welds are present), circuit breaker 710 may open circuit 700 to stop current flow when an overcurrent condition or short circuit condition occurs.

The above description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Unless the context clearly requires otherwise, throughout the description and the claims, the words “include,” “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description is not intended to be exhaustive or to limit the technology to the precise form disclosed above. While specific examples of the technology are described for illustrative purposes, various equivalent modifications are possible within the scope of the technology, as those skilled in the relevant art will recognize. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in several ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

What is claimed is:

1. A circuit breaker comprising:
a switch coupled to a rotary disk, wherein the switch rotates about a first axis, wherein the switch includes:
an on position corresponding to an on mode of the circuit breaker;
an off position corresponding to an off mode of the circuit breaker; and
a trip position corresponding to a trip mode of the circuit breaker;
the rotary disk comprising a receptacle disposed on a circumferential edge of the rotary disk, wherein the rotary disk rotates in a first plane about the first axis as the switch rotates, and wherein a movement of a linkage assembly is in response to rotation of the rotary disk; and
an interlock component comprising a hook extending from a circumferential edge of a circular body of the interlock component, wherein the interlock component and hook pivots in the first plane about a second axis parallel to the first axis in response to the movement of the linkage assembly, wherein:
the hook of the interlock component is aligned to interface with the receptacle of the rotary disk in an aligned position;
the hook of the interlock component is not aligned to interface with the receptacle of the rotary disk in an unaligned position;
in a normal operation of the circuit breaker, the interlock component pivots in response to movement of the linkage assembly from the aligned position corresponding to the switch in the on position to the unaligned position corresponding to the switch in the off position; and
in a tripping operation of the circuit breaker, the tripping operation comprising at least one of a set of moving contacts being welded to one of a set of stationary contacts, in response to rotation of the switch from the on position toward the off position:
the hook of the interlock component remains in the aligned position and interfaces with the receptacle of the rotary disk; and
the switch stops in the trip position in response to the hook interfacing with the receptacle of the rotary disk.

2. The circuit breaker of claim 1, further comprising the set of moving contacts coupled via the linkage assembly to the rotary disk, wherein:
the set of moving contacts change position between a first position corresponding to the on position of the switch and a second position corresponding to the off position of the switch in response to movement of the linkage assembly caused by rotation of the switch between the on position and the off position;
the set of moving contacts physically contact the set of stationary contacts in the first position corresponding to the on position of the switch allowing current flow through the circuit breaker in the on mode; and
the set of moving contacts do not contact the set of stationary contacts in the second position corresponding to the off position of the switch stopping current flow through the circuit breaker in the off mode.

3. The circuit breaker of claim 1, wherein the receptacle is at a first location on the circumferential edge of the rotary disk, and the rotary disk further comprises a gear interface disposed at a second location on the circumferential edge, the circuit breaker further comprising:
a gearing component coupled to the gear interface of the rotary disk and to the linkage assembly, wherein the gearing component translates rotation of the rotary disk to the movement of the linkage assembly axially along a third axis parallel to the first axis.

4. The circuit breaker of claim 1, further comprising the linkage assembly, wherein the linkage assembly comprises:
a rocker arm coupled to the set of moving contacts, wherein the movement of the linkage assembly moves the rocker arm and, in response, the set of moving contacts change position between a first position corresponding to the on position of the switch and a second position corresponding to the off position of the switch.

5. The circuit breaker of claim 1, further comprising the linkage assembly, wherein the linkage assembly is in a first position corresponding to the on position of the switch and in a second position corresponding to the off position of the switch, the linkage assembly comprising an extension component that pushes the interlock component into the aligned position in response to the movement of the linkage assembly into the first position.

6. The circuit breaker of claim 1, wherein:
the switch comprises a rotating knob;
the rotating switch rotates ninety degrees between the on position and the off position; and
the trip position is within the ninety degrees between the on position and the off position.

7. The circuit breaker of claim 1, further comprising an interlock component housing surrounding at least a portion of the interlock component, wherein the interlock component housing controls movement in at least one direction of the interlock component.

8. The circuit breaker of claim 1, wherein:
in normal operation:
in response to the switch rotating in a first direction from the on position to the off position:
the rotary disk rotates in the first direction and the interlock component rotates in a second direction opposite the first direction; and
in response to the switch rotating in the second direction from the off position to the on position:
the rotary disk rotates in the second direction and the interlock component rotates in the first direction.

9. The circuit breaker of claim 1, wherein the interlock component comprises plastic.

10. The circuit breaker of claim 1, wherein during the tripping operation of the circuit breaker, rotation of the switch applies a force on the hook of the interlock component from the rotation of the rotary disk, and wherein the hook of the interlock component can withstand the force of up to three and one half Newton-meters (3.5 Nm) before failing, wherein upon failing, the switch rotates to the off position and the at least one of the set of moving contacts remains welded to the one of the set of stationary contacts.

11. A circuit breaker, comprising:
a switch;
a rotary disk coupled to the switch, the rotary disk comprising a receptacle;
a linkage assembly coupled to the rotary disk;
a set of moving contacts coupled to the linkage assembly; and
an interlock component coupled to the linkage assembly, the interlock component comprising an interlocking hook, wherein:
in a healthy state of the circuit breaker:
the switch rotates from an on position corresponding to an on mode of the circuit breaker to an off position corresponding to an off mode of the circuit breaker;
in response to the rotation of the switch, the rotary disk rotates with the switch;
in response to the rotary disk rotating, the linkage assembly moves from a first position corresponding to the on mode of the circuit breaker to a second position corresponding to the off mode of the circuit breaker;
in response to the linkage assembly moving from the first position to the second position, the set of moving contacts disengage from a set of stationary contacts; and
in response to the linkage assembly moving from the first position to the second position, the interlock component rotates from an aligned position to an unaligned position; and
in an unhealthy state of the circuit breaker, the unhealthy state comprising at least one of the set of moving contacts being welded to one of the set of stationary contacts:
the switch rotates from the on position toward the off position;
in response to the rotation of the switch, the rotary disk rotates with the switch;
in response to the at least one of the set of moving contacts being welded to the one of the set of stationary contacts:
the linkage assembly remains in the first position;
the set of moving contacts remains engaged with the set of stationary contacts; and
the interlock component remains in the aligned position;
as the switch rotates toward the off position, the interlocking hook of the interlock component engages with the receptacle of the rotary disk; and
in response to the interlocking hook engaging with the receptacle, the switch does not rotate past a trip position between the on position and the off position.

12. The circuit breaker of claim 11, wherein the linkage assembly comprises a rocker arm coupled to the set of moving contacts, wherein:
in the healthy state, the movement of the linkage assembly moves the rocker arm and, in response, the set of moving contacts change position between a first position corresponding to the on position of the switch and a second position corresponding to the off position of the switch; and
in the unhealthy state, the at least one of the set of moving contacts being welded to the one of the set of stationary contacts resists movement of the rocker arm, maintaining the linkage assembly in the first position.

13. The circuit breaker of claim 11, wherein to be in the healthy state, no moving contacts of the set of moving contacts are welded to any stationary contacts of the set of stationary contacts.

14. The circuit breaker of claim 11, wherein the linkage assembly comprises an extension component that pushes the interlock component into the aligned position in response to the movement of the linkage assembly into the first position.

15. The circuit breaker of claim 11, wherein the interlock component is made of plastic.

16. The circuit breaker of claim 11, wherein while in the unhealthy state of the circuit breaker, rotation of the switch applies a force on the interlocking hook of the interlock component from the rotation of the rotary disk, and wherein the interlocking hook of the interlock component can withstand the force of up to three and one half Newton-meters (3.5 Nm) before failing, wherein upon failing, the switch rotates to the off position and the at least one of the set of moving contacts remains welded to the one of the set of stationary contacts.

17. A method of preventing a switch of a circuit breaker from being turned from an on position to an off position when contacts are welded together, the method comprising:
rotating the switch of the circuit breaker in a first direction from the on position toward the off position, wherein the switch is coupled to a rotary disk comprising a receptacle configured to engage with an interlocking hook of an interlock component of the circuit breaker when the interlock component is in an aligned position;
when the contacts are welded together, preventing the switch from being turned past an intermediary interlock position between the on position and the off position such that the switch cannot reach the off position, wherein preventing the switch from being turned past the intermediary interlock position comprises:
while the switch is rotated in the first direction from the on position toward the off position, stopping rotation of the rotary disk by engaging the receptacle of the rotary disk with the interlocking hook of the interlock component; and
stopping, via the interlocking hook, the rotary disk at a point of interlock, wherein the point of interlock corresponds to the intermediary interlock position of the switch; and
when the contacts are not welded together, enabling the switch to be turned from the on position to the off position by:
moving, by the rotary disk, a linkage assembly coupled to the rotary disk in a direction that separates moving contacts of the contacts from stationary contacts of the contacts, wherein the moving contacts are coupled to the linkage assembly; and
pulling, by one or more springs, a distal end of the interlock component coupled to the linkage assembly out of the aligned position to misalign the interlock component such that the interlocking hook does not engage with the receptacle of the rotary disk at the point of interlock.

18. The method of claim 17, further comprising:
rotating the switch in a second direction opposite the first direction from the off position to the on position; and
in response to rotating the switch in the second direction, rotating the interlock component to the aligned position.

19. The method of claim 17, further comprising allowing current to flow through the circuit breaker via the contacts when the moving contacts of the contacts are physically contacting the stationary contacts of the contacts.

20. The method of claim 17, further comprising withstanding a force of up to three and one half Newton-meters (3.5 Nm) on the interlocking hook of the interlock component applied by the rotation of the switch.
